(19) United States
(12) Patent Application Publication
(10) Pub. No.: US 2007/0258635 A1
(43) Pub. Date: Nov. 8, 2007

(54) APPARATUS AND METHOD FOR INSPECTING MASK FOR USE IN FABRICATING AN INTEGRATED CIRCUIT DEVICE

(75) Inventors: Do-Young Kim, Daejeon (KR); Dong-Hoon Chung, Gyeonggi-do (KR)

Correspondence Address: MARGER JOHNSON & MCCOLLOM, P.C., 210 SW MORRISON STREET, SUITE 400, PORTLAND, OR, 97204, US

(73) Assignee: Samsung Electronics Co., Ltd., Gyeonggi-do (KR)

(21) Appl. No.: 11/745,905

(22) Filed: May 8, 2007

(30) Foreign Application Priority Data
May 8, 2006 (KR) 2006-0041069

(51) Int. Cl. G06K 9/00

(52) U.S. Cl. 382/144

(57) ABSTRACT

In an embodiment, a mask inspection apparatus for detecting defects in a semiconductor pattern on a mask includes optics for combining light transmitted through or reflected from the mask with a reference beam. The two light beams are transmitted through a second-order non-linear optical system. Mask defects affect the transmitted/reflected light and may be detected by analyzing the transmitted light intensity. The second-order non-linear optical system amplifies selected elements of the combined beam, thus improving detection.

### CROSS-REFERENCE TO RELATED PATENT APPLICATION

This application claims the benefit of Korean Patent Application No. 10-2006-0041069, filed on May 8, 2006, in the Korean Intellectual Property Office, the disclosure of which is incorporated herein in its entirety by reference.

### BACKGROUND

1. Field of the Invention

The present invention relates to an apparatus and method for inspecting a mask having a semiconductor pattern for use in fabricating an integrated circuit (IC) device, and more particularly, to an apparatus and method for detecting defects in a semiconductor pattern on a mask for use in fabricating an IC device using a second-order non-linear optical system.

2. Description of the Related Art

A method of fabricating an integrated circuit (IC) device involves repeatedly performing various semiconductor processes including deposition, photo processing, lithography, ion implantation, and diffusion, such as on a silicon wafer. In this way, a large number of IC devices are batch fabricated on a single wafer.

The photo process includes forming a photoresist layer on a wafer and patterning the photoresist layer to form a semiconductor pattern on the wafer. This involves an exposure step where a mask having a semiconductor pattern is aligned over the wafer and light is irradiated onto the photoresist layer to transfer the semiconductor pattern to the wafer.

As demands for smaller and more functional IC devices increase, semiconductor pattern sizes formed on a mask are decreasing. This in turn increases the difficulty in detecting defects on the semiconductor pattern.

FIG. 1 is a diagram illustrating the arrangement of a mask 105 having a semiconductor pattern for use in fabricating an IC device, and a conventional mask inspection apparatus 101 for inspecting the semiconductor pattern. Referring to FIG. 1, the conventional mask inspection apparatus 101 includes an optical system 111 and an inspector 121.

The mask 105 is placed on a wafer (not shown), and a semiconductor pattern for forming semiconductor devices on the wafer is formed on the mask.

The optical system 111 includes a lens for transmitting an image P1 of the mask 105. The inspector 121 inspects the image P1′ passing through the optical system 111 to determine the presence or absence of defects in the semiconductor pattern.

The method for inspecting the mask 105 includes irradiating light PP onto the mask 105 and inspecting the waveform of the image P1′ obtained after the image P1 passes through the optical system 111. The irradiating light PP may, in general, have a large spot size, so that the whole mask 105 is irradiated at one time, or various parts of the mask 105 may be moved through the irradiating light PP (i.e., scanned) so that all areas of the mask 105 have their turn being irradiated, and thus inspected. When the waveform of the image P1′ is distorted, the semiconductor pattern on the mask may be determined to have a defect.

FIG. 2A is an example of a waveform diagram illustrating the intensity of an image P1 of the mask 105 shown in FIG. 1. FIG. 2B is a waveform diagram illustrating the intensity of the image P1′ after passing through the optical system 111 shown in FIG. 1.

FIGS. 2A and 2B show that the intensity of the image P1 is equal to that of the image P1′. That is, the image P1 of the mask 105 is not amplified as it passes through the optical system 111.

FIG. 3A is an example of a waveform diagram illustrating the intensity of the image P1 of the mask 105 when the semiconductor pattern on the mask 105 has a defect. Referring to FIG. 3A, when the semiconductor pattern is defective, a portion 311 of the waveform representing the intensity of image P1 of the mask 105 is distorted in some fashion. In this example, the intensity is lowered at a specific location because a defect here is blocking a portion of the transmitted light.

FIG. 3B is a waveform diagram illustrating the intensity of the image P1′ obtained after the image P1 has passed through the optical system 111. Referring to FIG. 3B, the intensity of the image P1′ is equal to that of the image P1 having the distorted portion 311 shown in FIG. 3A. The distorted portion 311 of the image P1 shown in FIG. 3A also has the same size as a distorted portion 31′ of the image P1′ that has passed through the optical system 111.

When the mask 105 has a defect, the width of the waveform representing the intensity anomaly of the image P1′ is so small that it can be very difficult detect. Thus, a defect in the semiconductor pattern on the mask 105 may be easily undetected. That is, because the semiconductor pattern on the mask 105 is very fine, the waveform representing the intensity of the image P1′ is so narrow that the image P1′ appears only slightly distorted if the semiconductor pattern has a defect. This makes it very difficult to distinguish the image having distortion (P1′ of FIG. 3B) from the normal image (P1′ of FIG. 2B).

Accordingly, as it is very difficult to find defects in the semiconductor pattern on the mask 105 using the conventional mask inspection apparatus 101, an improved apparatus and method is desired.

### SUMMARY

Some embodiments of the present invention provide an apparatus for inspecting a mask for use in fabricating an integrated circuit (IC) device, which can easily detect defects in a fine semiconductor pattern on the mask.

Embodiments of the present invention also provide a method for inspecting a mask for use in fabricating an IC device, which allows easy detection of defects in a fine semiconductor pattern on the mask.

According to an aspect of the present invention, there is provided a mask inspection apparatus for detecting defects in a semiconductor pattern on a mask for use in fabricating an IC device, including: an image combiner for receiving a mask image produced as a light beam passes through the mask and a reference beam having double the wavelength of the mask image, for combining the mask image with the reference beam, and for directing the combined images along the same path; a second-order non-linear optical system for receiving images from the image combiner and for increasing the intensity of the incident images; and an inspection unit for inspecting the images leaving the second-order non-linear optical system and for determining whether a defect is present in the semiconductor pattern on the mask. The apparatus may further include an image separator for separating the images leaving the second-order non-linear optical system according to wavelength and for projecting the separate images onto the inspection unit.

In another embodiment, a mask inspection apparatus for detecting defects in a semiconductor pattern on a mask for use in fabricating an IC device includes: an image combiner for receiving a mask image produced by reflecting a light beam from the mask and a reference beam having double the wavelength of the mask image, for combining the mask image with the reference beam, and for directing the combined images along the same path; a second-order non-linear optical system for receiving images from the image combiner and for increasing the intensity of the incident images; and an inspection unit for inspecting the images leaving the second-order non-linear optical system and for determining whether a defect is present in the semiconductor pattern on the mask. The apparatus may further include an image separator for separating the images leaving the second-order non-linear optical system according to wavelength and for projecting the separate images onto the inspection unit.

According to another aspect, there is provided a mask inspection method for detecting defects in a semiconductor pattern on a mask for use in fabricating an IC device, including: irradiating light onto the mask; combining a mask image leaving the mask with a reference beam having double the wavelength of the mask image; increasing the intensity of the combined images as they pass through the second-order non-linear optical system; separating the images leaving the second-order non-linear optical system according to wavelength; and inspecting the separate images.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating the arrangement of a mask having a semiconductor pattern for use in fabricating an integrated circuit (IC) device, and a conventional mask inspection apparatus for inspecting the semiconductor pattern;

FIG. 2A is a waveform diagram illustrating the intensity of an image of the mask shown in FIG. 1;

FIG. 2B is a waveform diagram illustrating the intensity of an image passing through the optical system shown in FIG. 1;

FIG. 3A is a waveform diagram illustrating the intensity of an image of the mask shown in FIG. 1 when the semiconductor pattern on the mask has a defect;

FIG. 3B is a waveform diagram illustrating the intensity of an image obtained after the image shown in FIG. 3A has passed through the optical system shown in FIG. 1;

FIG. 4 is a diagram illustrating the arrangement of a mask having a semiconductor pattern for use in fabricating an IC device, and a mask inspection apparatus for inspecting the semiconductor pattern according to an embodiment of the present invention;

FIG. 5A is a waveform diagram illustrating the intensity of an image of the mask shown in FIG. 4;

FIG. 5B is a waveform diagram illustrating the intensity of a reference beam incident on the image combiner shown in FIG. 4 from the outside;

FIG. 5C illustrates a state in which the mask image shown in FIG. 5A has been combined with the reference beam shown in FIG. 5B;

FIG. 6A is an example of a waveform diagram illustrating the intensity of an image passing through the second-order non-linear optical system shown in FIG. 4;

FIG. 6B is another example of a waveform diagram illustrating the intensity of an image passing through the second-order non-linear optical system shown in FIG. 4;

FIG. 7A is an example of a waveform diagram illustrating the intensity of an image of the mask shown in FIG. 4 when the semiconductor pattern on the mask has a defect;

FIG. 7B is a waveform diagram illustrating the intensity of an image obtained after the image shown in FIG. 7A has passed through the second-order non-linear optical system shown in FIG. 4;

FIG. 8 is a graph of simulation results for a mask image entering the second-order non-linear optical system shown in FIG. 4 and images leaving the second-order non-linear optical system;

FIG. 9 a diagram illustrating the arrangement of a mask having a semiconductor pattern for use in fabricating an IC device, and a mask inspection apparatus for inspecting the semiconductor pattern according to another embodiment of the present invention; and

FIG. 10 is a flowchart illustrating a method for inspecting a mask according to an embodiment of the present invention.

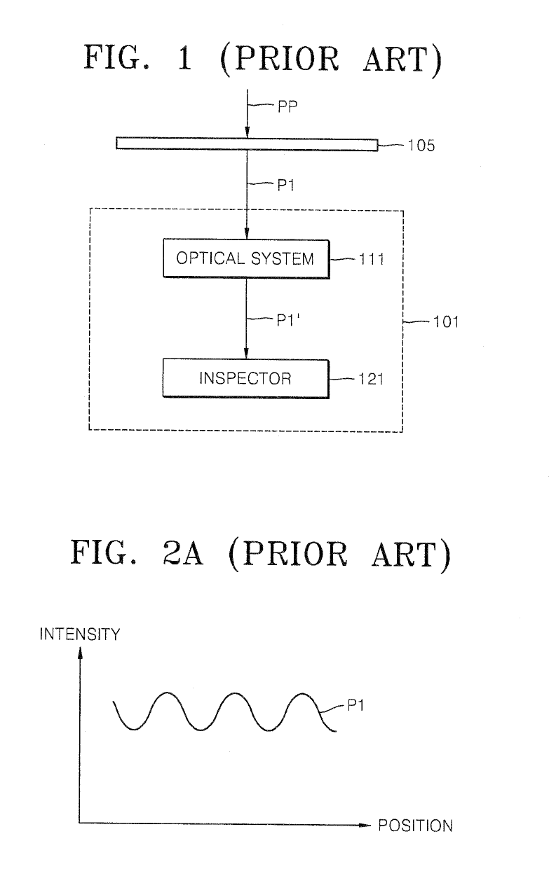

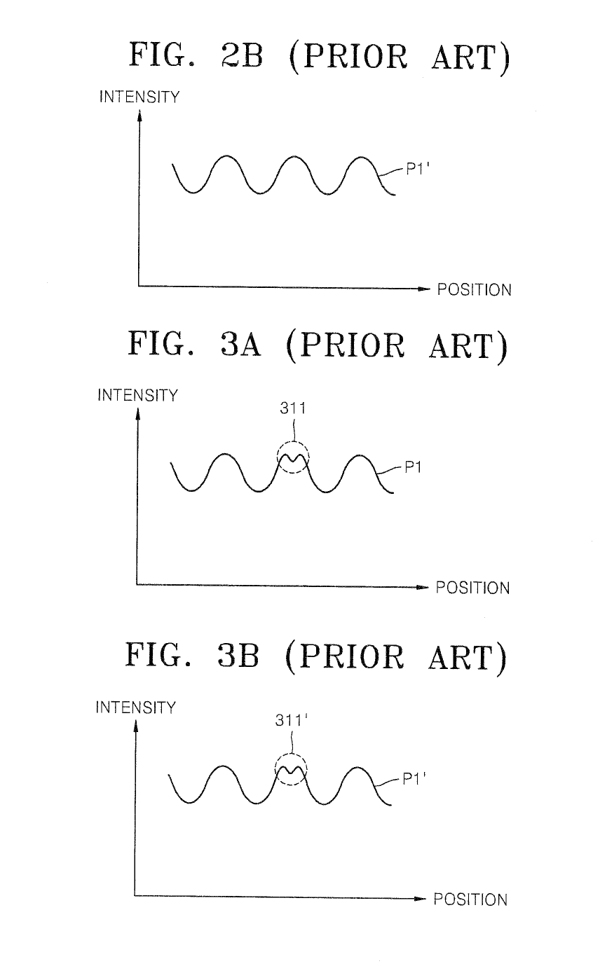

### DETAILED DESCRIPTION

The present invention will now be described more fully with reference to the accompanying drawings, in which exemplary embodiments of the invention are shown. Like reference numerals denote like elements in the drawings.

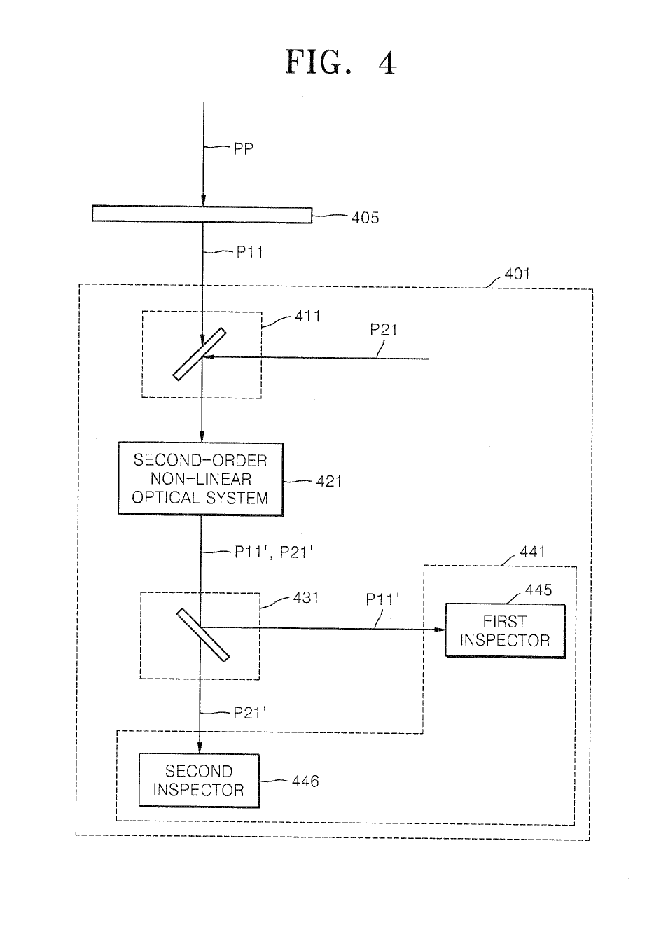

For an embodiment, FIG. 4 illustrates the arrangement of a mask 405 having a semiconductor pattern for use in fabricating an integrated circuit (IC) device (not shown), and a mask inspection apparatus 401 for inspecting the semiconductor pattern. The mask inspection apparatus 401 includes an image combiner 411, a second-order non-linear optical system 421, an image separator 431, and an inspection unit 441. In this embodiment, the inspection unit 441 includes first and second inspectors 445 and 446.

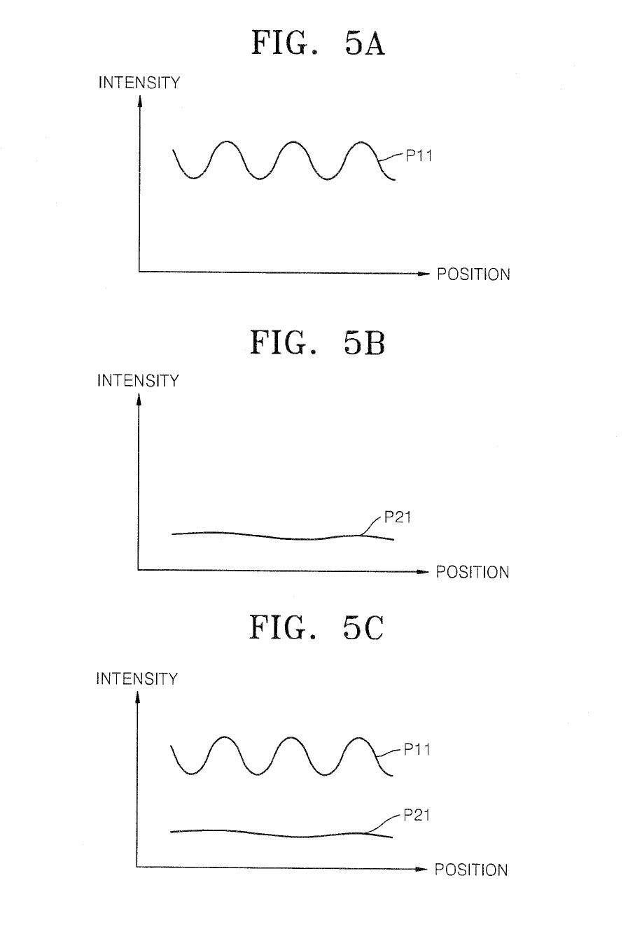

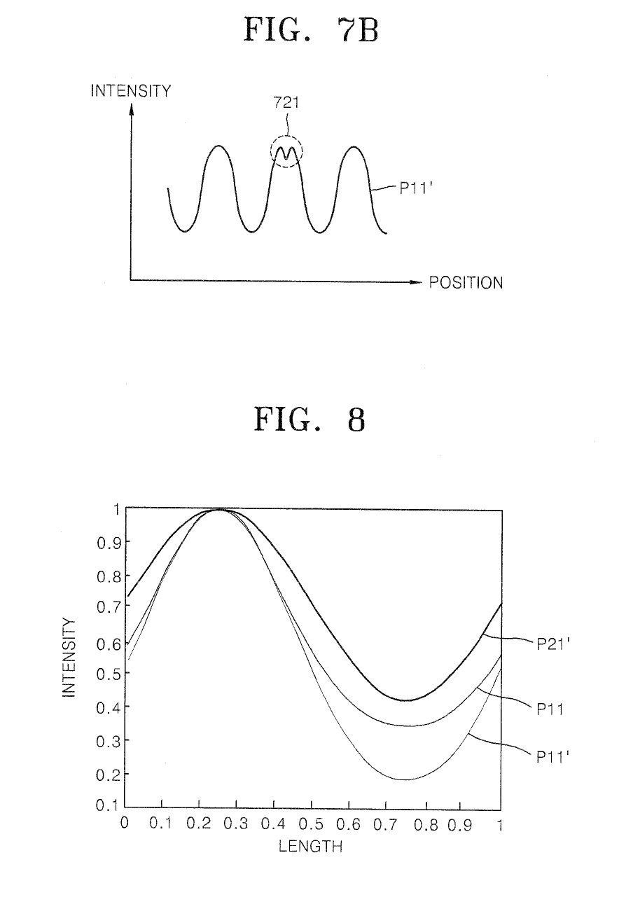

The mask 405 is used to fabricate an IC device and has a semiconductor pattern for forming semiconductor devices on a wafer (not shown). Because the semiconductor pattern on the mask 405 is very fine, it cannot be distinguished with the naked eye. The semiconductor pattern consists of transparent and opaque portions. Thus, when light (e.g. a laser beam) is irradiated onto the mask 405 to detect defects in the semiconductor pattern on the mask 405, a mask image (P11 of FIGS. 5A and 7A) exits the mask 405. That is, light that has passed through transparent portions of the semiconductor pattern on the mask 405 has a high intensity, while light that has passed through opaque portions of the semiconductor pattern has a very low intensity. Thus, the intensity of the mask image P11 of the mask 405 will generally be represented by a periodic waveform as illustrated in FIG. 5A that varies with a location of transmission on the mask 405. The shape of this waveform, of course, depends on the pattern details of the mask.

The image combiner 411, which may be a dichroic filter, combines the mask image P11 of the mask 405 with a reference beam P21 incident from the outside, and projects the combined images P11 and P21 along the same path into a second-order non-linear optical system 421. The mask image P11 enters the image combiner 411 along a different path than the reference beam P21, while both the images P11 and P12 travel the same path to the second-order non-linear optical system 421. The reference beam P21 has preferably double the wavelength (2λ) of the mask image P11 (λ).

The second-order non-linear optical system 421 selectively increases the intensity of the images P11 and P21 incident from the image combiner 411 before directing them to the image separator 431. The second-order non-linear optical system 421 significantly increases the intensity of one of the mask image P11 and the reference beam P21 so that it is higher than the original intensity of the mask image P11. The second-order non-linear optical system 421 may include a single crystal such as LBO (Li₂B₄O₇), Beta-Barium Borate (BBO), KH₂PO₄ (KDP), KTiPO₄ (KTP), KNBO₃, Periodically Poled LiNbO₃ (PPLN), rubidium titanyl arsenate (RTA), PPKTP, BIBO (BiB₃O₆), PPO potassium niobate (PPKN), or PPRTA.

The image separator 431, which may be a dichroic filter, separates images P11′ and P21′ from the second-order non-linear optical system 421 according to wavelength, and projects the image P11′ having a wavelength of λ and the image P21′ having a wavelength of 2λ (in the preferred embodiment) respectively onto first and second inspectors 445 and 446 in the inspection unit 441.

The first inspector 445 analyses the intensity of the image P11′ having a wavelength of λ, by checking for the presence of distortion in the P11′ waveform. The first inspector 445 determines that the semiconductor pattern on the mask 405 is defective if distortion is present in the waveform. Conversely, when no distortion is present in the waveform, the first inspector 445 determines that the semiconductor pattern is not defective.

The second inspector 446 analyzes the intensity of the image P21′ having a wavelength of 2λ, by checking for the presence of distortion in the P21′ waveform. The second inspector 446 determines that the semiconductor pattern on the mask 405 is defective if distortion is present in the waveform. Conversely, when no distortion is present in the waveform, the second inspector 446 determines that the semiconductor pattern is not defective.

The first and second inspectors 445 and 446 may each include a Charge Coupled Device (CCD) camera or Time Delay and Integration (TDI) sensor to receive incident images, a monitor displaying the images, and a controller analyzing the images.

The second-order non-linear optical system 421 can increase the intensity of only one of the incident mask image P11 and the reference beam P21. Thus, by selectively inspecting an image having a higher intensity than the original mask image P11, the first and second inspectors 445 and 446 can precisely determine the presence of defects in the semiconductor pattern on the mask 405. That is, when the intensity of the image P11′ having a wavelength of λ is higher than that of the mask image P11, the first inspector 445 detects defects in the semiconductor pattern on the mask 405, and when the intensity of the image P21′ having a wavelength of 2λ is higher than that of the mask image P11, the second inspector 446 detects defects in the semiconductor pattern.

As described above, the mask inspection apparatus 401 according to the present embodiment can precisely detect defects in the fine semiconductor pattern on the mask 405 by increasing the intensity of the mask image P11 and the reference beam P21 as the combined images P11 and P21 pass through the second-order non-linear optical system 421.

The mask inspection apparatus 401 also allows one of the plurality of inspectors 445 and 446 to inspect the image P11′ or P21′ having a higher intensity than the original mask image P11, thus enabling precise determination of the presence of defects in the semiconductor pattern.

FIG. 5A is an example of a waveform diagram illustrating the intensity of the image P11 of the mask (405 of FIG. 4). The intensity of the mask image P11 leaving the mask 405 can be represented by a periodic waveform.

FIG. 5B is an example of a waveform diagram illustrating the intensity of the reference beam P21 incident on the image combiner (411 of FIG. 4) from the outside. The intensity of the reference beam P21 has a direct current (DC) level. That is, the intensity of the reference beam P21 has no particular waveform feature since it has not traversed a mask.

FIG. 5C illustrates both the mask image P11 shown in FIG. 5A and the reference beam P21 shown in FIG. 5B. The combined mask image P11 and reference beam P21 from the image combiner 411 are projected onto the second-order non-linear optical system (421 of FIG. 4).

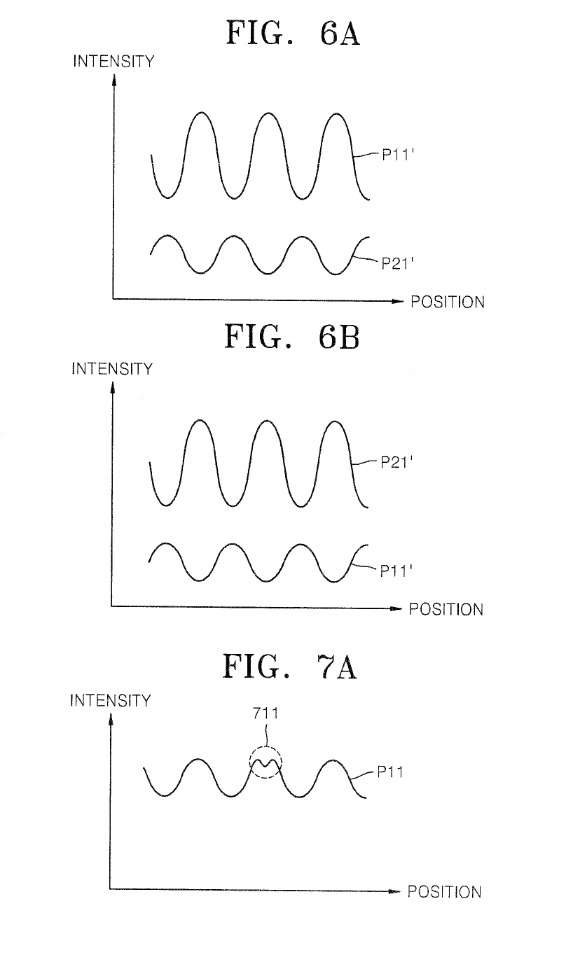

FIG. 6A is an example of a waveform diagram illustrating the intensity of the images P11′ and P21′ from the second-order non-linear optical system 421. The intensity of one of the images P11′ and P21′ is higher than that of the original image P11 in FIG. 5A of the mask 405. For example, the image P11′ having a wavelength of λ has a significantly higher intensity than the mask image P11, while the image P21′ having a wavelength of 2λ has a lower intensity than the mask image P11, but image P21′ has gained the waveform structure of the mask image P11 by passing through the second-order non-linear optical system 421.

FIG. 6B is another example of a waveform diagram illustrating the intensity of images P11′ and P21′ from the second-order non-linear optical system 421. Again, the intensity of one of the images P11′ and P21′ is higher than that of the image P11 in FIG. 5A of the mask 405. This time, in contrast to the last example of FIG. 6A, the image P11′ having a wavelength of λ has a lower intensity than the original mask image P11, while the image P21′ having a wavelength of 2λ has a significantly higher intensity than the original mask image P11.

FIG. 7A is an example of a waveform diagram illustrating the intensity of an image P11 of the mask 405 when the semiconductor pattern on the mask 405 has a defect. As illustrated in FIG. 7A, when the semiconductor pattern is defective, a portion 711 of a waveform representing the intensity of the mask image P11 is distorted.

FIG. 7B is a waveform diagram illustrating the intensity of an image P11′ obtained after the image P11 shown in FIG. 7A has passed through the second-order non-linear optical system 421. As illustrated in FIG. 7B, when the semiconductor pattern on the mask 405 has a defect, a distorted portion 721 of one of the images P11′ and P21′ leaving the second-order non-linear optical system 421 is significantly enlarged. Thus, by inspecting the image P11′ having the enlarged distorted portion 721 of the images P11′ and P21′ from the second-order non-linear optical system 421, any defects in the semiconductor pattern can be precisely detected by making their effects on the image P11′ or P21′ easier to see.

FIG. 8 is a graph of simulation results for a mask image P11 entering the second-order non-linear optical system 421 and images P11′ and P21′ leaving the second-order non-linear optical system 421. FIG. 8 shows that one (P11′) of the images P11′ and P21′ has an intensity that is 20% higher than that of the mask image P11.

The contrast of the images P11, P11′, and P21′ is defined by Equation (1):

$$C = \frac{{I}_{max} - {I}_{min}}{{I}_{max} + {I}_{min}} \qquad ( 1 )$$

where Iₘₐₓ and Iₘᵢₙ respectively denote the maximum and minimum intensities of the images P11, P11′ and P21′.

By inspection of Equation (1), one can see that merely amplifying the image P11, perhaps by electronically amplifying its signal, will not affect the contrast C. This is because the amplification factor will cancel out of the equation. But by passing the image P11 through the second-order non-linear optical system 421, Iₘₐₓ is increased by a greater amount than that of Iₘᵢₙ. The simulation examples of FIG. 8 show this, as follows.

For mask image P11, the maximum and minimum intensities Iₘₐₓ and Iₘᵢₙ are respectively 1.0 and 0.35. Thus, the contrast of the mask image P11 is about 0.48.

The maximum and minimum intensities Iₘₐₓ and Iₘᵢₙ of the image P11′ from the second-order non-linear optical system 421 are respectively 1.0 and 0.18. Thus, the contrast of the image P11′ is 0.69.

As described above, the image P11′ from the second-order non-linear optical system 421 has a contrast that is more than 20% higher than that of the mask image P11 entering the second-order non-linear optical system 421. This increased contrast helps to detect waveform anomalies in the mask image caused by mask defects.

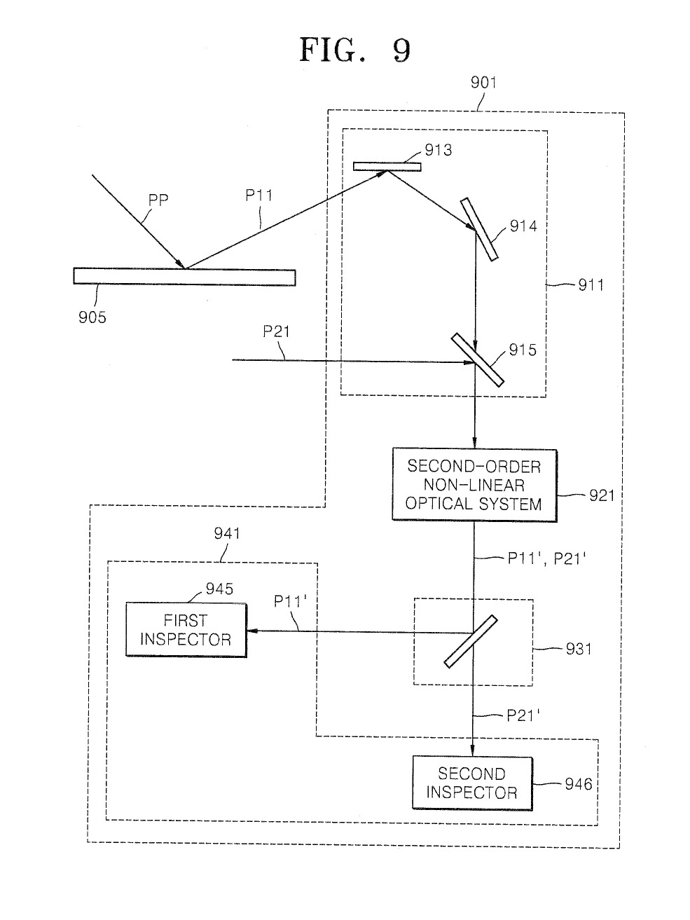

FIG. 9 is a diagram illustrating the arrangement of a mask 905 having a semiconductor pattern for use in fabricating an IC device, and a mask inspection apparatus 901 for inspecting the semiconductor pattern according to another embodiment of the present invention. In this embodiment, a mask image P11 is produced by reflection of incident light from the mask 905, whereas the mask image P11 of the embodiment of FIG. 4 is produced by transmission of incident light through the mask 405.

The mask inspection apparatus 901 includes an image combiner 911, a second-order non-linear optical system 921, an image separator 931, and an inspection unit 941 including first and second inspectors 945 and 946.

The mask 905, the second-order non-linear optical system 921, the image separator 931, and the inspection unit 941 have substantially the same structure and function as their counterparts in FIG. 4, and thus a detailed explanation thereof will not be given.

The mask image P11 is produced by irradiating light PP onto the mask 905. The image combiner 911 receives the mask image P11 from the mask 905 and a reference beam P21 from the outside. The image combiner 911 then combines the incident mask image P11 and reference beam P21 and projects them onto the second-order non-linear optical system 921. The image combiner 911 may include one or more mirrors 913 and 914 and a dichroic filter 915 that transmits light of one wavelength and reflects light of another wavelength. The mirrors 913 and 914 reflect the mask image P11 from the mask 905 onto the dichroic filter 915. The dichlroic filter 915 transmits the incident mask image P11 and reflects the reference beam P21 incident from the outside, both to the second-order non-linear optical system 921.

The mask inspection apparatus 901 according to the current embodiment can precisely detect defects in a fine semiconductor pattern on the mask 905 by increasing the intensity and contrast of the mask image P11 and the reference beam P21 as the combined images P11 and P21 pass through the second-order non-linear optical system 421.

The mask inspection apparatus 901 also allows one of the plurality of inspectors 945 and 946, which receives the image P11′ or P21′ having the higher intensity than the mask image P11, to inspect that image. This enables a precise detection of defects in the semiconductor pattern.

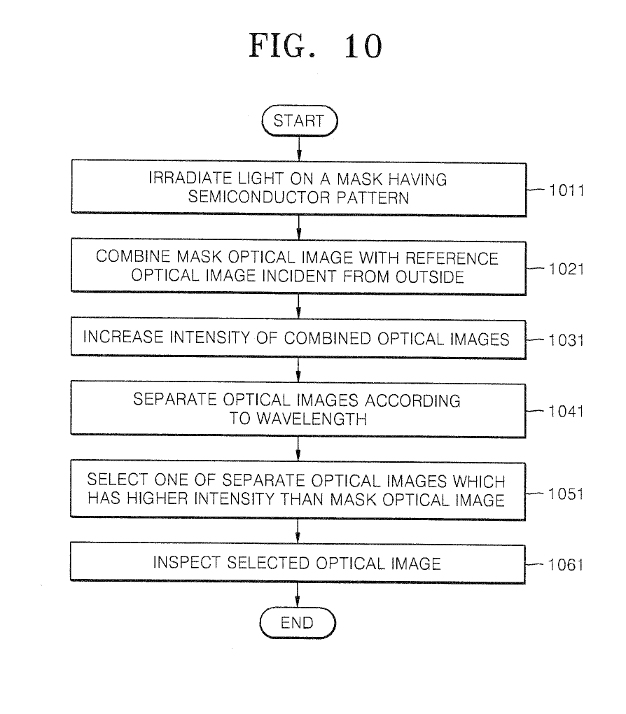

FIG. 10 is a flowchart illustrating a method for inspecting a mask according to an embodiment. The mask inspection method includes six steps S1011 through S1061.

In step S1011, light is irradiated onto the mask (405 of FIG. 4, for example).

In step S1021, a mask image P11 of the mask 405 is combined with a reference beam P21 having double the wavelength of the mask image P11. That is, the mask image P11 has a wavelength of λ while the reference beam P21 has a wavelength of 2λ, in this embodiment.

In step S1031, the intensity of one of the combined images P11 and P21 is increased as the combined images P11 and P21 pass through the second-order non-linear optical system (421 of FIG. 4, for example). The contrast of the original image P11 is also increased.

In step S1041, the combined images P11′ and P21′ leaving the second-order non-linear optical system 421 are then separated into the image P11′ having a wavelength of λ and the image P21′ having a wavelength of 2λ, according to wavelength.

In step S1051, the one of the separated images P11′ and P21′ that has a higher intensity than the original mask image P11 is selected.

In step S1061, it is determined whether any defect is present in the semiconductor pattern on the mask 405 by inspecting the selected image.

As described above, the mask inspection method and apparatus can increase the apparent size of a defect of the semiconductor pattern on the mask by increasing the intensity and contrast of the mask image P11 and the reference beam P21 as the combined images P11 and P21 pass through the second-order non-linear optical system 421, thus allowing precise detection of defects in the semiconductor pattern.

The mask inspection method and apparatus also enable precise detection of defects in the semiconductor pattern by selectively inspecting one of the images P11′ and P21′ leaving the second-order non-linear optical system 421, which has a significantly higher intensity than the original mask image P11 reflected from the mask 405.

The mask inspection apparatus 401 or 901 also enables precise detection of defects in the semiconductor pattern by transmitting a plurality of images P11′ and P21′ from the second-order non-linear optical system 421 or 921 to the plurality of inspectors 445 and 446 or 945 and 946 and allowing the one of the plurality of inspectors 445 and 446 or 945 and 946 which receives the one of the plurality of transmitted images P11′ and P21′ which has a significantly higher intensity than the mask image P11 to inspect the significantly enlarged image.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A mask inspection apparatus for detecting defects in a semiconductor pattern on a mask for use in fabricating an IC (Integrated Circuit) device, the apparatus comprising:
an image combiner for receiving a mask image produced by a light beam incident on the mask and for receiving a reference beam, for combining the mask image with the reference beam to form a combined image, and for directing the combined image along a same path, wherein the mask image includes a waveform that is responsive to the semiconductor pattern on the mask;
a second-order non-linear optical system for receiving the combined image, which comprises the mask image and the reference beam, from the image combiner and for increasing the intensity of one of the mask image and the reference beam; and
an inspection unit for determining whether a defect is present in the semiconductor pattern on the mask by inspecting images, which are responsive to the combined image, exiting the second-order non-linear optical system.

2. The apparatus of claim 1, wherein the light beam incident on the mask is transmitted through the mask to the image combiner.

3. The apparatus of claim 1, wherein the light beam incident on the mask is reflected from the mask to the image combiner.

4. The apparatus of claim 1, wherein the reference beam has twice the wavelength of the mask image.

5. The apparatus of claim 1, wherein the intensity of the reference beam has a DC (Direct Current) level.

6. The apparatus of claim 1, wherein the image combiner is a dichroic filter for transmitting the mask image while reflecting the reference beam.

7. The apparatus of claim 1, wherein the second-order non-linear optical system includes one selected from the group consisting of LBO (Li₂B₄O₇), BBO (Beta-Barium Borate), KH₂PO₄ (KDP), KTiPO₄ (KTP), KNBO₃, and PPLN (Periodically Poled LiNbO₃).

8. The apparatus of claim i, further comprising an image separator for separating the images exiting the second-order non-linear optical system according to wavelength and for projecting the separate images onto the inspection unit.

9. The apparatus of claim 8, wherein the image separator includes a dichroic filter.

10. The apparatus of claim 8, wherein the inspection unit includes a plurality of inspectors, each inspector adapted to receive one of a plurality of images from the image separator, and further adapted to determine whether a defect is present in the semiconductor pattern on the mask by inspecting the respectively received images.

11. The apparatus of claim 1, wherein the light beam is a laser.

12. The apparatus of claim 1, wherein the second-order non-linear optical system increases the contrast of the mask image.

13. The apparatus of claim 1, wherein the images exiting from the second-order non-linear optical system comprise a first image that has the same wavelength and the same, but intensified, waveform as the mask image, and a second image that has the same waveform, but twice the wavelength as the mask image.

14. The apparatus of claim 1, wherein the images exiting from the second-order non-linear optical system comprise a first image that has the same, but intensified, waveform as the mask image and twice the wavelength of the mask image, and a second image that has the same wavelength and waveform as the mask image.

15. A mask inspection method for detecting defects in a semiconductor pattern on a mask for use in fabricating an IC (Integrated Circuit) device, the method comprising:
irradiating light onto the mask;
combining a mask image leaving the mask with a reference beam;
increasing the intensity of the combined images as they pass through the second-order non-linear optical system;
separating the images exiting the second-order non-linear optical system according to wavelength; and
inspecting the separated images.

16. The method of claim 15, wherein inspecting the separated images comprises:
selecting one of the separated images that is intensified compared to the mask image; and
inspecting the selected image to determine whether a defect is present in the semiconductor pattern on the mask.

17. The method of claim 15, further comprising increasing the contrast of the mask image by passing the mask image through the second-order non-linear optical system.

18. The method of claim 15, further comprising transmitting or reflecting the irradiating light through/from the mask to produce the mask image that comprises a waveform that is responsive to the semiconductor pattern on the mask.

19. The method of claim 18, further comprising modifying the combined images using the second-order non-linear optical system so that the exiting images comprise a first image that has the same wavelength and the same, but intensified, waveform as the mask image, and a second image that has the same waveform, but twice the wavelength as the mask image.

20. The apparatus of claim 18, further comprising modifying the combined images using the second-order non-linear optical system so that the exiting images comprise a first image that has the same, but intensified, waveform as the mask image and twice the wavelength of the mask image, and a second image that has the same wavelength and waveform as the mask image.

21. The apparatus of claim 15, further comprising producing the reference beam to have a wavelength that is twice that of the mask image.

22. A mask inspection apparatus for detecting defects in a semiconductor pattern on a mask for use in fabricating an IC (Integrated Circuit) device, the apparatus comprising:
a second-order non-linear optical system for receiving a mask image and a reference beam having a wavelength that is double that of the mask image, wherein the mask image is responsive to the semiconductor pattern; and
an inspection unit for determining whether a defect is present in the semiconductor pattern on the mask by inspecting images exiting the second-order non-linear optical system.
